(19) United States
(12) Patent Application Publication
(10) Pub. No.: US 2007/0239485 A1
(43) Pub. Date: Oct. 11, 2007

(54) System and method for providing telediagnostic services

(76) Inventor: Brian J. Sroub, Chagrin Falls, OH (US)

Correspondence Address: JEANNE E. LONGMUIR, 2836 CORYDON ROAD, CLEVELAND HEIGHTS, OH, 44118, US

(21) Appl. No.: 11/701,844

(22) Filed: Feb. 1, 2007

Related U.S. Application Data
(60) Provisional application No. 60/764,283, filed on Feb. 1, 2006.

(51) Int. Cl. G06Q 50/00

(52) U.S. Cl. 705/2

(57) ABSTRACT

A system and method for efficient screening or diagnosis of analytes from fluids and cells, some of which are generated by live organisms, as well as other fluids, such as water, which are ingested or contacted by living organisms, provided via telediagnostic services using internet enabled computer system that allows laboratories to select a variety of desired testing methods. The present system and method includes: 1) obtaining the fluid or cellular sample; 2) capturing images of the sample electronically using a microscope/digital camera combination; 3) storing the electronic images on a local computer and then forwarding the image to a remote central computer system via the internet; 4) processing the electronic images using high-speed customer management and order processing e-commerce software programs and optional laboratory selected machine vision software routines, and reviewed by remote panels of individual technicians using telediagnostics systems: 5) results are processed, reviewed summarized in a report and returned to the laboratory.

### CROSS REFERENCE TO RELATED APPLICATION

This application claims priority from U.S. patent Application Serial No. 60,764,283 filed Feb. 1, 2006 entitled System and Method for Scoring Objects and Mobile Analyte Screening, the entire subject matter of which is incorporated herein by reference.

### FIELD OF THE INVENTION

This application provides an improved system and method for providing telediagnostic services, and more specifically to an internet enabled computer system and method that allows laboratories to select a variety of desired methods to provide efficient screening or diagnosis of analytes from fluids and/or cells.

### BACKGROUND OF THE INVENTION

As medicine advances, we realize the health and well being of living organisms is controlled by developments occurring at the microscopic level. Viruses, parasites, cancer cells, and DNA, to name only four, are not visible to the unaided human eye, but each can have profound influences on the body that carries them. In laboratories, clinics, hospitals and doctors' offices, technicians often use microscopes in search of markers to provide clues regarding the health of the bodies that generated them. Additionally, other types of chemical, molecular and other tests may also be conducted, such as PCR, flow cytometry and other non-morphological techniques, which highlight the presence or absence of biological elements, such as anti-bodies or amino acids, to indicate a particular biological state. The general practice of this type of analysis is generally referred to as clinical diagnostics. For the purposes of this application, we also include potable water analysis and the analysis of other external substances that live organisms might contact as part of clinical diagnostics.

Today, samples are extracted from a patient in a variety of medical settings and then sent to a laboratory for evaluation. With respect to microscopic review, once at the laboratory, the sample is often stained with dyes and evaluated. Most evaluations are conducted manually by a trained technician examining the sample under a microscope looking for presence or absence of markers that may be used to indicate the illness or wellness of a patient. An alternate method of sample evaluation involves the use of machines. Such diagnostic machines are generally designed to detect a limited set of disease states with costs running into six figures. As practical matter, no lab can analyze every disease presented. As a result many samples are sent between labs so the lab most familiar with a particular disease state may be employed.

These prior art microscopy methods present many shortcomings. First, the manual inspection of slides though a microscope causes significant technician fatigue, which may result in a technician having difficulty delivering consistently accurate results throughout an entire shift. The literature consistently sites technician fatigue as a significant cause of misdiagnosed samples. Second, these methods are expensive and time consuming to physically ship and manually evaluate the samples. This practice causes record keeping challenges as well as added cost. In recent years, clinics have been under severe pricing pressure from insurance companies, employers and the government to reduce costs. Third, this approach requires several days to several weeks for the originating laboratory or lab to secure results. This waiting period delays the physician/patient interaction with the diagnosis, as well as critical treatment and patient compliance. Fourth, there are safety concerns when dangerous or infectious substances (e.g. anthrax, smallpox) are sent through the mail. Fifth, there is a shortage of qualified technicians, especially in developing countries. Sixth, since no single lab can contain the world's leading experts on all disease states, there is necessarily a lack of comprehensive expertise for every disease state in any one lab. Additionally, machine evaluation is often only as good as the last software update. Seventh, developing countries lack the medical infrastructure of schools, training and practices to staff a lab in sufficient numbers to handle their large populations. Finally, developing countries cannot afford the capital costs of the machines or the startup training costs to train a team of technicians.

The first step in treating any disease is securing a diagnosis. Doctors gather a variety of input from the patient toward that end including lifestyle information, measuring physical symptoms and performing formal tests. These formal tests frequently involve removing fluids (e.g. blood, sputum, urine, etc.) and/or tissue from the patient for microscopic analysis described previously.

No tests are error free. The cause of error is many-fold. Even if the patient is afflicted, the sample may not contain the organism that the laboratory technician is looking for; the technician may not examine the portion of the sample containing the marker; subsequent handling may have obscured the marker; the lab may have misinterpreted the markers in the sample; or the lab may have mishandled or mislabeled the sample; or many other causes.

Understanding the potential for error, doctors generally consider many different sources of information before rendering a diagnosis under the belief that a larger collection of data points will reduce the likelihood of an incorrect diagnosis. Despite these difficulties, the “gold standard” for data used in a diagnosis continues to be the isolation of a visual marker associated with a particular disease.

Two U.S. Pat. Nos. 6,603,535 and 5,905,568, address a Stereo Imaging Velocimetry (SIV) system which teaches a machine visioning method for forming an adaptive, morphological computer neural network that identifies and classifies objects based on a set of feature criteria developed through interaction with expert technicians most advanced in their specific disease states. A related Compact Microscope Imaging System (CMIS) (patent pending) which incorporates an automated microscope to dynamically photograph samples has also been developed. Although SIV and CMIS were developed for evaluation of samples on the space shuttle, the technology may be used in the clinical diagnostics market. The direct application of SIV and CMIS could address certain of the problems described earlier. The present application, in addition to the features described, also reduces the amount of human interaction required to develop and update an adaptive neural network, increases the number of available testing methods, all of which may optionally be conducted with technician oversight, and makes use of a mobile apparatus for easy field use.

In recent years, telediagnostics have grown in popularity as a way to provide diagnoses to geographically remote patients or labs. So far, most of these telediagnostic services have centered on cytology (study of cells) or radiology (x-rays of lungs and larger body parts). Prior art systems and methods are generally provided by licensed doctors vs. laboratory technicians.

### SUMMARY OF THE INVENTION

This application relates to the efficient screening or diagnosis of analytes from fluids and cells, some of which are generated by live organisms, as well as other fluids, such as water, which are ingested or contacted by living organisms, and includes an improved system and method for providing telediagnostic services via an internet enabled computer system that allows laboratories to select a variety of desired testing methods. Several points of disintermediation are provided in the improved system and method of the present application, including the separation of the sample extraction and the sample image capture, the separation of the image capture and the analysis, and the ability to provide the originating laboratory with significant choice in the cost and rigor of the analytical method used to interpret the sample.

The system and method includes five basic steps: 1) the fluid or cellular sample is obtained; 2) images of the sample are captured electronically using a microscope/digital camera combination (herein referred to as an “interscope”), which may be a general-purpose device usable for many lab functions; 3), the electronic images are stored on a local computer and then forward to a remote central computer system via the internet; 4) the electronic images are processed remotely using high-speed customer management and order processing e-commerce software programs and laboratory selected machine vision software routines, and reviewed by remote panels of individual technicians using telediagnostics systems. Following processing, the images are again stored in a database for future reference and data mining. In step 5), the results obtained during processing and review are summarized in a report and returned to the laboratory. The report may include the indicated diagnosis, the confidence rating of the diagnosis, the bacilli count (if machine vision is used), images highlighting the location of the bacilli (if positive), and technician comments (if the panels are used and comments are available).

Qualified technicians are enlisted from around the world to form panels of technicians. Such individual technicians are capable of evaluating the desired and selected disease states. Once enlisted, technicians access the present system remotely by logging onto the system internet site, identifying themselves through conventional security software, and taking an on-line test to evaluate their skills in reading samples. This test has sufficient security protocols to ensure the test cannot be defeated with automated routines. Upon passing the test, technicians are admitted to the qualified technician pool or panel, and are assigned an initial skill rating.

During initial processing and any machine vision review of the images of the samples, objects within a sample are evaluated against predetermined disease state values. Either real time or accumulated Once a work order has accumulated, email correspondence is forwarded to the qualified technicians from the pool to solicit bids, alternatively fixed bids may be sought and accepted, from the technicians for the work order. Each interested qualified technicians submits a bid. Work orders are then awarded to the qualified technicians with the winning bids. Work orders may have multiple technicians screening or reviewing the same image samples. Bids may be awarded based on pricing and/or ratings of individual technicians. Ratings reflect test performance and job performance. Once work orders are awarded, the winning technicians again remotely access the present system for further access to the image samples for review and submission of their evaluations. The evaluations may be reviewed by a system administrator for similarity and reliability. For example, if all technicians rate the image objects the same way, the interpretation has a higher rating of reliability. If the technicians provide different evaluations, such as a 50/50 split, the interpretations are less highly rated for reliability. Technicians are preferably paid via credit card transactions. Following their review, the technicians are also evaluated and their ratings updated taking into consideration the success of their individual review, and the system's adaptive neural network is also updated accordingly.

The interscope device for obtaining electronic images from samples for use in the system and method of the present application may include a conventional device, or preferably, an improved approximately pocket sized device similar in form and operation to a personal digital assistant or PDA. The interscope device includes an embedded software storage device, software routines, neural networks, etc. The device also has a communication support to forward sample images to the central system database.

Additionally, the interscope device may be provided with software for receiving updated adaptive neural network information, perhaps via a subscription model. Analyte drawn from a variety of sources, including water, is placed on the device for scanning and storage of an electronic image of the sample. The electronic image sample may then either be forwarded via the internet to the central computer system for further analysis, evaluation and reporting.

### BRIEF DESCRIPTION OF THE DRAWINGS

FIG. 1 schematically illustrates the system and method of the present application for providing telediagnostic services via an internet enabled computer system allowing laboratories to select a variety of desired methods to provide efficient screening or diagnosis of analytes.

FIG. 2 illustrates a more detailed schematic of the system and method of the present application for providing telediagnostic services via an internet enabled computer system allowing laboratories to select a variety of desired methods to provide efficient screening or diagnosis of analytes.

FIG. 3 schematically illustrates the system and method of the present application and the more detailed aspects of the method for obtaining qualified technician pools or panels for review and evaluation of image samples using the present system and method.

FIG. 4 schematically illustrates an example of a report of the review and evaluation resulting from use of the present system and method for providing telediagnostic services.

FIG. 5 schematically illustrates a device for electronically capturing images of analyte samples to be evaluated using the system and method of the present application.

### DETAILED DESCRIPTION OF THE PREFERRED EMBODIMENT

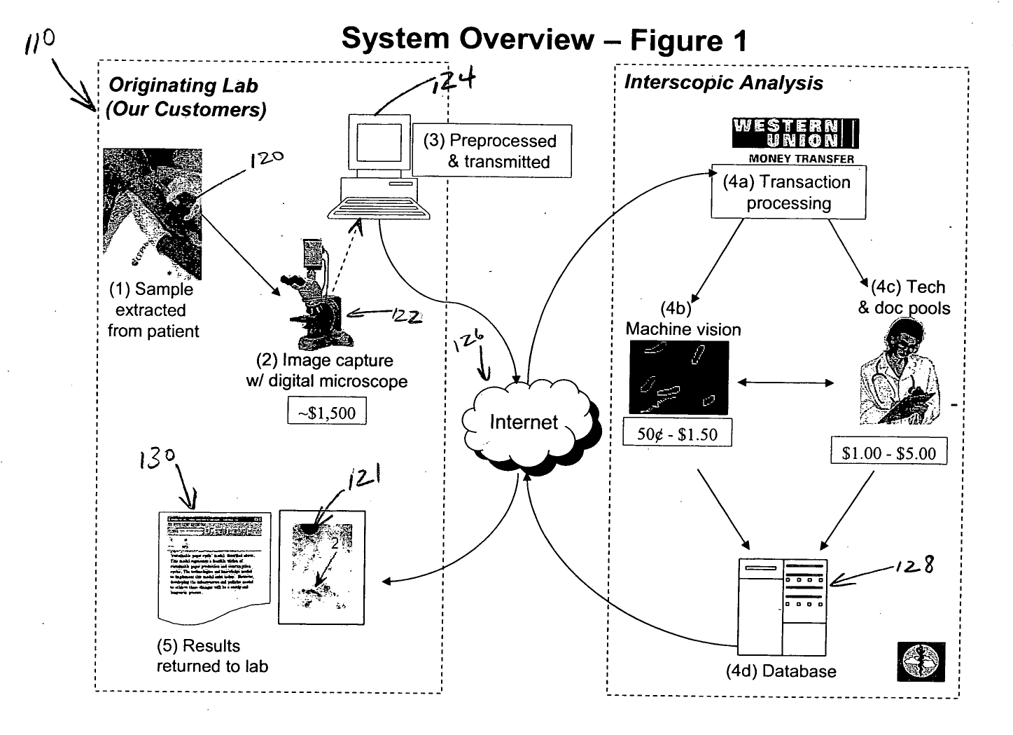

FIG. 1 of the present application provides a schematic diagram of an overview of the present system and method of the present application for providing telediagnostic services via an internet enabled computer system which allows laboratories to select a variety of desired methods to provide efficient screening or diagnosis of analytes.

The system, generally referenced at 110, and method includes the steps as illustrated in FIG. 1. First, the sample 120 is obtained, for example, when a clinic draws and processes a sample 120. Second, images 121 of that sample 120 are electronically captured using a microscope/digital camera combination or an interscope 122. The interscope 122 may be a general-purpose piece of equipment usable for many lab functions, and costs anywhere from $1,000 to $1,500. Third, the electronic sample images 121 are stored on a local computer 124 and then sent to remote system servers over the internet 126. Internet 126 access is currently available in most major cities in the ascending world at costs under $250 per month. Electronic image 121 sizes are approximately 1 megabyte per sample 120 and are electronically transmitted in under a minute. A DICOM-compliant compression routine may also be used that would further reduce image size. In step four, images 121 are automatically processed using high-speed e-comnierce systems for customer management and order processing, including a variety of payment methods such as credit card or money transfer, as shown at 4a in FIG. 1. Machine vision routines (for ˜$1.50 per screen) may also be used as desired and selected by the laboratory, and as shown at 4b in FIG. 1. Remote technician panels using telediagnostics systems (for ˜$5-$20 per screen) may also be used as shown at 4c in FIG. 1. The electronic images 121 are stored in a central computer system database 4d for future reference and data mining. Finally, in step five, the results are summarized in a report 130 and returned to the originating laboratory. The report 130 includes the indicated diagnosis, the confidence rating of the diagnosis, the bacilli count (if machine vision is used), images 121 highlighting the location of the bacilli (if positive), and technician comments (if the technician panels are used and any comments are made).

Current manual microscopy rarely generates a photograph of the positive marker identification that the present system generates. This photograph or image 121 provides the originating laboratory with important feedback for the patient and the physicians or other medical care providers. The labs use the highlighted image, shown in FIG. 1 in step 5 at reference 2, for example, with the patient to drive home the accuracy of the diagnosis, which encourages higher treatment compliance. The photograph or image 121 also provides the physicians with an audit loop to ensure accuracy.

System Architecture

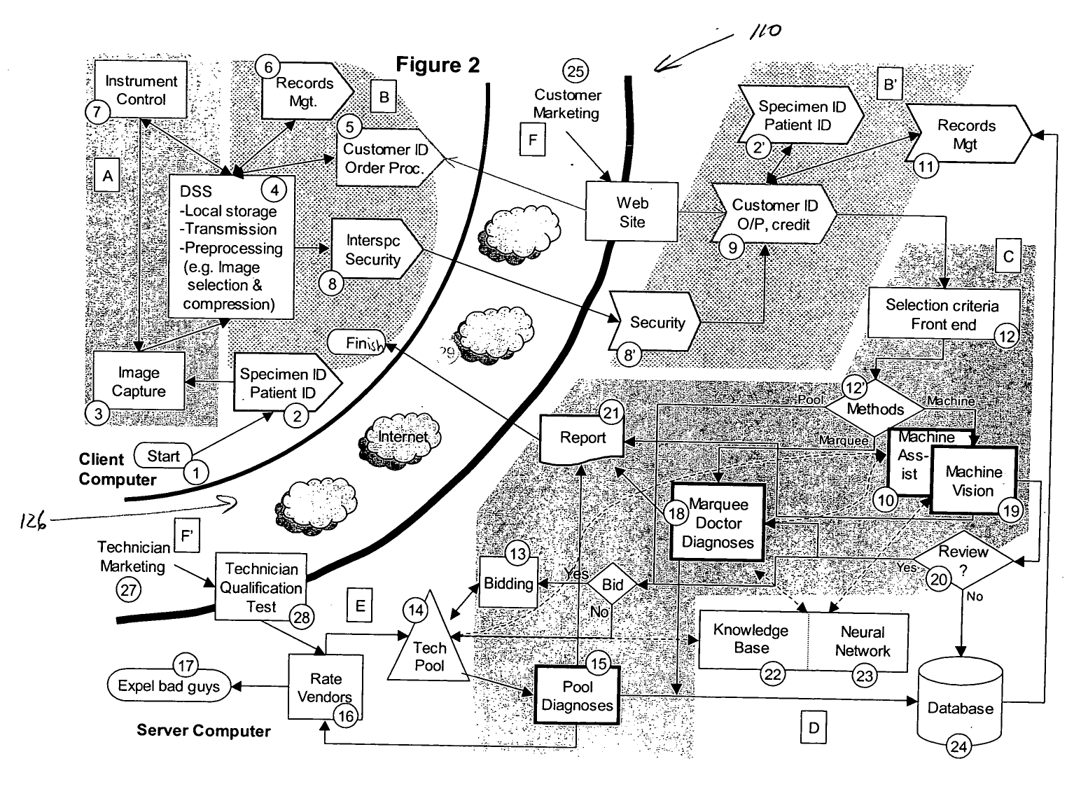

FIG. 2 schematically illustrates the present system architecture. The present system 110 makes use of a variety of commercially available software programs, for example, the Windows XP operating system platform and suite of programs, and MatLab software for machine vision assist. The system is composed of six broad subsystems, referenced as follows: A=Image Capture subsystem; B=Records Management and Security subsystem; C=Image Analysis subsystem; D=Database and Knowledge Management subsystem; E=Technician/Doctor Pool Management subsystem; F=External Management and Recruiting subsystem.

The current preferred embodiment of the system and method begins at reference 1 in FIG. 2, when a technician in the client laboratory electronically tells the present system 110, using the Image Capture subsystem referenced at A, that it is planning to capture an image 121 using the interscope equipment 122. The image 121 is assigned a Specimen identification number (ID #) and a Patient identification number (ID #) as shown at reference, which enters a preliminary request for processing into the Records Management and Security subsystem shown at reference B. Once a valid Patient ID is received, the image capture is accepted, as shown at reference 3 from the digital camera attached to the local microscope equipment 122. Preferably, the system 110 uses a fully integrated microscope/camera unit. Still within the client computer, this captured image 121 is then passed to a decision support system or DSS, referenced at 4 in FIG. 2, which is loaded on a local personal computer 124 which stores the image 121 in a temporary electronic file. The file is then examined to determine if it is acceptable for analysis using a pre-screen routine. If additional images are required, the DSS sub-subsystem communicates that to the instrument control software, referenced at 7 in Image Capture subsystem referenced at A in FIG. 2, and additional images are captured at reference 3 and reanalyzed within the DSS sub-subsystem referenced at 4.

Once the DSS sub-subsystem has determined that acceptable images 121 have been captured, the images are compressed and stored on the local computer 124 based on a coordinated set of criteria which includes the account status of the customer, referenced at 5 in FIG. 2. The files are then pre-processed within the DSS sub-subsystem in anticipation of transmission to the central computer system which may include compression, parsing and encryption at reference 8 in FIG. 2.

The images 121 are then sent over the internet 126 to a receiving security routine referenced at 8′ within the Records Management and Security subsystem referenced at B′ within the central system located remotely from the originating lab in FIG. 2. Following financial processing, referenced at 9 in FIG. 2, the customer is validated and passes to valid status. The Specimen and Patient 1D numbers referenced at 2′ are then added to the Records Management and Security subsystem B′ and a transaction record is issued as referenced at 11. A valid customer with a valid set of images 121 is now in place in the system 110 of the present application.

Using the system's software customer interface application accessed via the internet, the customer is then presented electronically with a set of testing or method choices referenced at 12 within the Image Analysis subsystem C in FIG. 2. These choices determine how the customer wants the images 121 to be analyzed. The current range of alternatives is described in greater detail hereinafter. However, three broad classes of alternatives are available: Machine vision (and machine assist) as referenced at 19, identified (also described as Marquee) doctors and/or technicians as referenced at 18, and unidentified technicians and/or doctors from pools as referenced at 14. If the client selects the unidentified technician pool, they may choose to have bids conducted on their jobs or go directly to a listed or fixed price from the technicians in the pool. If the job is bid out, the qualified technicians are notified by electronic communications or email, regarding a newly available job and bids are solicited. More detail on the bidding process is provided hereinafter. Once an acceptable set of bids is received, the job is awarded from the technician pool referenced at 14. The technicians have access to the electronic knowledge base within the present system, referenced at 22, to check and improve their diagnostic capabilities, in exchange for consideration. The chosen pool resource(s) then generate a diagnosis with respect to the sample image, which diagnosis is reported and referenced at 15. The results of that diagnosis are recorded in the raw database 24 and the knowledge base 22 which in turn updates any neural network 23 in place within the Database and Knowledge Management subsystem D within the system 110.

If the client lab selects a Marquee Doctor referenced at 18 to conduct the diagnosis, a similar set of steps are followed except that those doctors are less likely to engage in a bidding process since they are identified from the start. The diagnosis 15 is reported as described above.

The client lab may also choose to having the image analyzed using machine vision software routines 19 or using machine assist 10. The machine vision routines 19 process the images using a series of procedures which ultimately generate a probabilistic identification of the markers within the analyte sample image. From time to time, the machine vision routines are reviewed or audited to ensure they are generating accurate results. To do so, the services of the Marquee Doctors 18 and/or the services of the technician pool 14 may be employed. The results of those audits are then recorded in the raw database 24 and the knowledge base 22 which in turn updates the neural network 23.

The client lab may also choose to analyze the image 121 on their own after the images have been modified and enhanced using machine assist 10 routines. If such a selection is made, the electronic image is processed using a series of procedures that make it easier for a human to visually identify markers within the image 121. The doctors 18 and the technicians in the pool 14 may also employ machine assist 10 for consideration as well.

The results of the various analytical methods selected by the originating laboratory or client, are consolidated in an electronic, printable report format referenced at 21 and sent electronically over the internet 126 to the client laboratory.

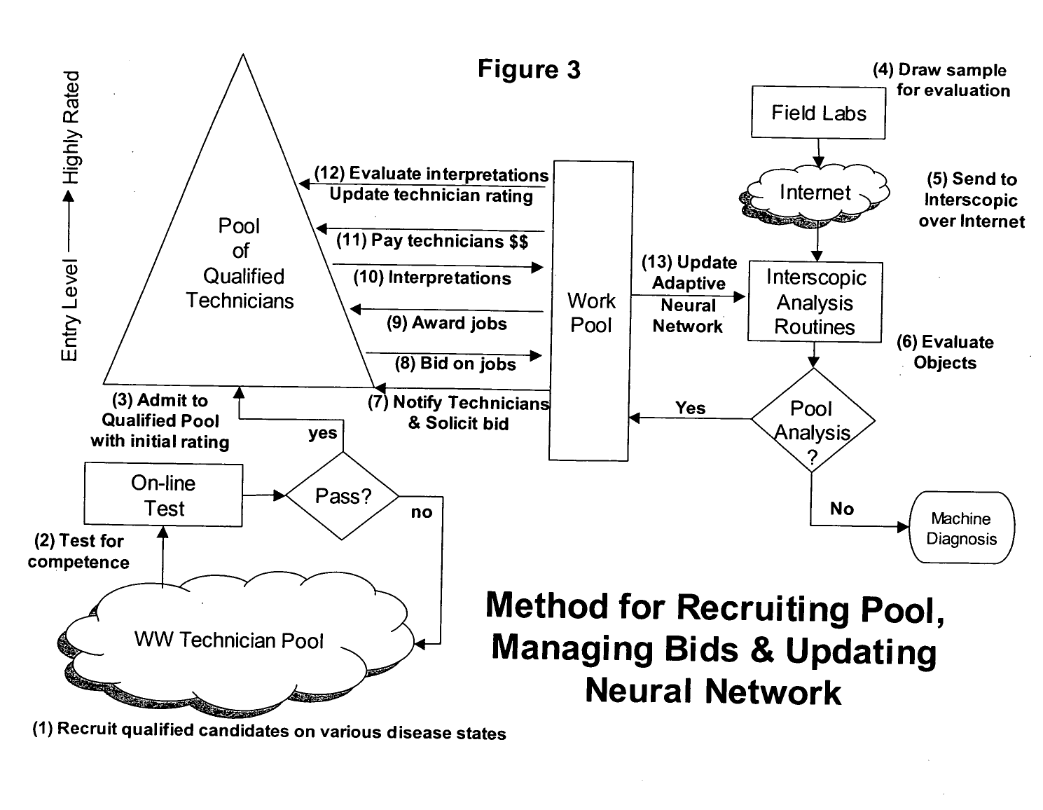

In the Technician/Doctor Pool Management subsystem referenced at E in FIG. 2 and in more detail in FIG. 3, the pool technicians 15 and doctors 18 are managed using rating software. To qualify to initially enter the pool, a technician must take and pass a qualifying test referenced at 28 in FIG. 2, to correctly identify the markers required for the relevant disease state. Once they pass the test, they are placed in the pool 14 and are given a rating that reflects their test score and their experience level. Each time they are chosen to perform an analysis or diagnosis, their rating is adjusted. Their rating goes up if they perform “good analyses” as defined by lab client ratings and other considerations, and it goes down if their work is substandard. If a technician's rating gets too low, they are expelled from the pool as shown at reference 17.

The system employs a variety of outreach techniques in the External Management and Recruiting subsystem referenced at F. The system 110 is optimized to attract traffic among target labs via customer marketing referenced at 25 and technician marketing referenced 27, both of which are conducted via the internet. Cross-linking, banners and other marketing techniques may also be used as appropriate.

Bidding Process

FIG. 3 further describes the sequence of the bidding process in the technician pool. First, qualified technicians are recruited from around the world that are capable of evaluating the desired disease states. Internet sites, search and various trade publications may be used to target the talent search. Second, interested technicians apply to the system web site via the internet, identify themselves, and take the on-line test to evaluate their skills in reading samples. This test has sufficient security to ensure the test cannot be defeated with automated routines. Third, after passing the test, the technicians are admitted to the qualified Technician Pool. They are assigned an initial rating. Fourth, laboratories, clinics, hospitals and doctors' offices from around the world gather analyte samples which are photographed with a digital camera or interscope 122. Fifth, the samples 120 are electronically forwarded for processing and analysis over the internet 126 for evaluation. Sixth, determinations are made by the client laboratory regarding whether these images are to be evaluated using the technician pool or by another method such as machine vision. Seventh, once a batch of work orders has accumulated, emails are forwarded to the qualified technicians from the Technician Pool to solicit bids on the work. Eighth, technicians from the pool submit their bids. Ninth, the jobs are awarded to the winning bidders. Jobs may have multiple technicians screening the samples. Bids will be awarded based on price of bid, the rating of technician and other considerations made available to the originating lab. Ratings reflect test performance and on-the-job performance and other considerations. Tenth, technicians electronically submit their interpretations, which are evaluated for reliability. For example, if all technicians rate object is same way, interpretation is thought to be reliable. If the technicians split 50/50 on a rating, interpretations are considered suspect. Eleventh, technicians are paid, preferably with a credit via credit card or other electronic money transfer. Twelfth, the technicians themselves are evaluated and their ratings are updated. For example, if a technician misread the sample, their rating will be downgraded; if they were successful, their rating will be improved. Finally, any adaptive neural network 23 used within the system 110 is updated to reflect the latest interpretations.

Doctor and Technician Pool Characteristics

The pool members are characterized by a range of attributes. These attributes may become part of the pool members rating or may also be discretely selectable by client labs. They include:
Level of education (MD, PhD, MS, BS, technician, medical student, high school equivalent, none)
Professional status (Practicing doctor, researcher, technician, etc.)
Country of residence
Countries certified to practice
Ratings based on client lab feedback
Willingness to converse and consult with client labs
Years of experience. Age
Test scores
How recruited (e.g. Personal interviews, referrals, Internet based, dedicated contract, etc.)
Degree of anonymity/recognition
Price of diagnosis. Contract pricing. Willingness to engage in bids.
   Consolidated Reporting

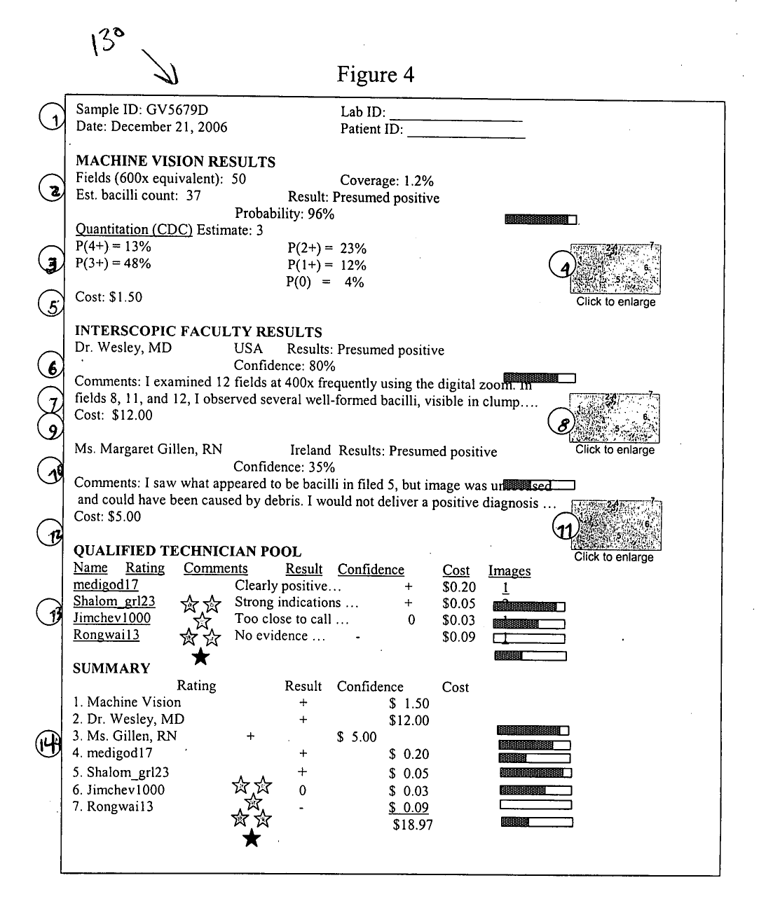

To illustrate the power and intuitiveness of the consolidated report 130 provided by the system 110, a sample is provided as shown in FIG. 4. This report 130 is best experienced on-screen where click through and drill down reports are available, but it may be printed as well. This sample report 130 is written to reflect the identification of TB bacilli, but the principles are applicable to other disease states as well.

At the top of the report at reference 1, a patient identification, a sample identification, a laboratory identification and dates are provided. This report includes machine vision results at reference 2, including an estimate of the number of fields that have been examined, an estimated bacilli count, sample coverage, result and probability rating regarding the diagnosis. The results are further reported into an estimated quantization rating referenced at 3 as defined by the Centers for Disease Control (CDC) and the American Thoracic Society (ATS). A point estimate along with a probability distribution is provided. An image referenced at 4 is also provided that shows the presence of bacilli. In the on-screen interactive version, these images may be clicked to create an enlarged image for further inspection. In the printed version of this report, full-page images are available to attach to the report. The cost at 5, of the machine vision diagnosis may also be included.

This report 130 also includes a report from a marquee doctor faculty member referenced at 6. The doctor's name, his country of residence, diagnosis and his personal confidence ratings are provided. Additionally his comments referenced at 7 are reported, any relevant images referenced at 8 and the cost of his services at 9 are reported.

This report 130 also includes an analysis from a nurse referenced at 10 from Ireland including her diagnosis and personal confidence estimate. This nurse also has included an image in her report referenced at 11 and well as her cost at 12 of services.

This report further includes four ratings from the qualified technician pool referenced at 13. The first observation comes anonymously from a technician with the handle “medigod17” who carries a two star rating, which may be color coded. His short comments are included as well at his indicated diagnosis and confidence rating. He has further attached an image, which can be clicked through. His cost is also reported. Likewise the other three anonymous technicians have included similar information. The results are then summarized at reference 14 in a concise consolidated report 130.

This reporting system gives the client lab and doctors more confidence in the test results since they have been reviewed by six unrelated medical care providers as well as a machine vision routine. Further, they can share multiple images of the TB bacilli with the patient to reinforce the validity of the diagnosis. This added value will allow the labs to charge more for the test and will further convince the patient of the test's validity. This is important since many patients are prone to denial regarding their diagnoses and frequently do not comply with treatment.

Mobile Interscope Device

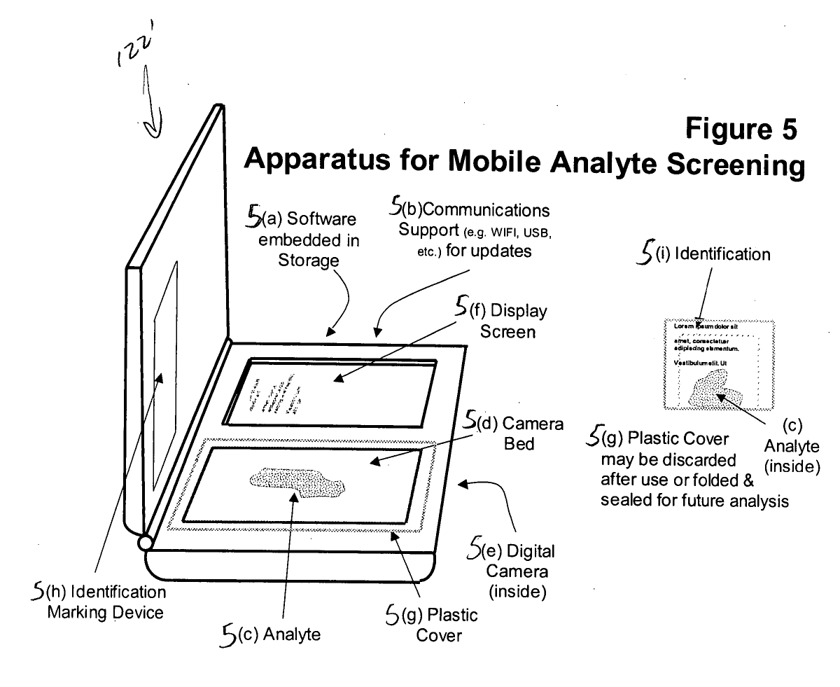

A device 122′ for mobile analyte screening is illustrated in FIG. 5. The overall apparatus is pocket sized similar in form factor to a PDA. Embedded in a storage device internal to the device is software, routines, neural networks, etc., referenced at 5a, similar in functionality to the web based service offering provided by the present system 110. The preferred embodiment is to hardwire and encrypt the routines so that it cannot be copied by third parties. The device 122′ also has a communication support 5b to both send back sample images to a remote database associated with the present system 110, for updating and receive updated adaptive neural network information, perhaps via a subscription model. Analyte drawn from a variety of sources is placed on a camera bed 5d for analysis. When the device is activated, the digital camera Se inside the device 122′ scans analyte 5c and evaluates objects within the analyte. Once screening is complete results of the screen are reported on the display screen 5f. The device is equipped with supply of plastic covers 5g which are placed between the device 122′ and the analytes 5c. This cover 5g prevents contamination of the device from past analytes. However, it should be understood that for certain analyte samples no cover may provide optimal screening, and in such instances a cover is not used, and the camera bed is cleaned using available and appropriate cleaners. Once analysis is complete, the plastic cover 5g may be removed and discarded, or it may be folded over and sealed with a light adhesive. Further, the device also may have a stamping device 5h that automatically burns the plastic cover with the time, date and other identifying information. This stamping device 5h may be thermal or light based in nature.

It should be understood that commonly used computer terminology used herein should be given its ordinary and customary meaning in the industry. While the present improved methods, processes, system and device have been described herein in connection with one or more embodiments, it is understood that they should not be limited in any way, shape or form to any specific embodiment but rather constructed in broad scope and breadth in accordance with the recitation of the following claims.

I claim:

1. A system for efficient screening of sample analytes from fluids and/or cells obtained at a laboratory which allows the laboratory to select a variety of desired testing methods, the system comprising:
a. a sample image capture subsystem located at a laboratory having a combination microscope and digital camera for electronically capturing an image of a sample analyte;
b. a local laboratory computer having memory for storing the captured image of a sample analyte and capable of accessing the internet;
c. a central computer system, located remote from the laboratory, including a records management and security subsystem for safely accessing the internet and capable of receiving the captured image of a sample analyte from a laboratory;
d. an image analysis subsystem enabling a laboratory sending the captured image of a sample analyte to select the desired testing methods to which the captured image of a sample analyte is desired to be submitted from a predetermined list of testing methods;
e. said predetermined list of testing methods provided to the laboratory having at least two testing methods for identification of different specific disease states, and including a choice regarding whether a medical technician and/or medical doctor provided from a pool of predetermined medical technicians and/or medical doctors, conducts the selected tests;
f. said central computer system automatically processes the captured image using high-speed e-commerce systems for handling customer management, payment and order processing;
g. said image analysis subsystem submits the captured image of a sample analyte to the selected testing methods, and results are obtained and stored in a database and knowledge management subsystem, and electronically reported to the laboratory.

2. The system of claim 1 wherein said predetermined list of testing methods further includes an option of having the testing method performed using a machine and machine vision software routines.

3. A method for efficiently screening sample analytes from fluids and/or cells collected by a laboratory, comprising the steps of
a. electronically capturing a sample image within an image capture subsystem located at a laboratory using a combination microscope and digital camera;
b. storing the captured image of a sample analyte in computer memory of a laboratory computer capable of accessing the internet;
c. accessing the internet to securely transmit the captured image of a sample analyte from a laboratory to a central computer system located remote from the laboratory;
d. enabling a laboratory sending the captured image of a sample analyte to select the desired testing methods to which the captured image of a sample analyte is desired to be submitted from a predetermined list of testing methods;
e. providing said predetermined list of testing methods with at least two testing methods for identification of different specific disease states;
f. providing said predetermined list of testing methods with a choice regarding whether a medical technician and/or medical doctor provided from a pool of predetermined medical technicians and/or medical doctors, conducts the selected tests;
g. automatically processing the captured image using high-speed e-commerce systems for handling customer management, payment and order processing;
h. submitting the captured image of a sample analyte to the selected testing methods using an image analysis subsystem;
i. obtaining and storing test results in a database and knowledge management subsystem; and
j. reporting electronically the test results to the laboratory.

4. The method of claim 3 further comprising the step of providing the predetermined list of testing methods includes performing the testing methods on a machine using machine vision software routines.
